(19) United States
(12) Patent Application Publication
(10) Pub. No.: US 2014/0005902 A1
(43) Pub. Date: Jan. 2, 2014

(54) Machine Speed Limit Control

(71) Applicants: Venkatramanan Venkatachalam Ananthasivan, Simpsonville, SC (US); Alexander Babbe, St. Saviour (GB); Christopher Crawford, Peterborough (GB); Michael D. Smith, Cambridgeshire (GB)

(72) Inventors: Venkatramanan Venkatachalam Ananthasivan, Simpsonville, SC (US); Alexander Babbe, St. Saviour (GB); Christopher Crawford, Peterborough (GB); Michael D. Smith, Cambridgeshire (GB)

(73) Assignee: PERKINS ENGINE COMPANY LIMITED, Peterborough (GB)

(21) Appl. No.: 14/006,335

(22) PCT Filed: Mar. 20, 2012
(86) PCT No.: PCT/GB12/50607

§ 371 Date: Sep. 20, 2013

(30) Foreign Application Priority Data
Mar. 21, 2011 (GB) 1104757.8

(51) Int. Cl. B60W 10/06; B60W 10/10

(52) U.S. Cl. CPC B60W 10/06; B60W 10/10
USPC 701/54

(57) ABSTRACT

An engine forming part of a machine is controlled in order to effect a predetermined machine speed limit. One or more engine control parameters are determined based on a theoretical engine speed limit that is based on the predetermined machine speed limit and variable machine parameters. This comprises on or more of: varying a control software engine speed limit from a first engine speed value to a desired engine speed limit value that is based on the theoretical limit; setting the control software engine speed limit at a locked engine speed limit value that remains constant when the theoretical limit is within a set range; setting an engine governor gain based on the theoretical limit; setting control software engine speed filter parameters based on the theoretical limit; and determining control commands to prevent the machine transmission from changing gears based on the engine speed limit with a hysteresis applied.

### TECHNICAL FIELD

The disclosure relates to: a method of controlling an engine forming part of a machine, such as an automotive machine; a computer program, configured when operated on a processor to carry out the method; and an engine controller for effecting a predetermined machine speed limit in an engine that forms part of a machine, such as an automotive machine.

### BACKGROUND

For many engine-based machines, it is desirable for some applications to limit the machine speed in some way. A machine speed limit may be similar to the “cruise control” facility on highway vehicles, in that the engine may be controlled so that the machine speed does not exceed a predetermined limit. Speed limiters are also implemented in other automotive designs. For example, public service and large goods vehicles often use maximum speed limiters to prevent exceeding legal speed limits and racing cars employ speed limiters to meet imposed speed limits in pit lanes.

Engine design typically uses digital logic or software control, for example as part of an Electronic Control Module or Unit (ECM or ECU). Existing approaches to achieving machine speed limit typically set an engine speed limit of the ECU control algorithm. It may be desirable to implement machine speed limiting in such a way as to improve fuel consumption and engine efficiency.

### SUMMARY OF THE DISCLOSURE

An engine forms part of a machine. A method of controlling the engine in order to effect a predetermined machine speed limit comprises: determining one or more control parameters for the engine on the basis of a theoretical engine speed limit that is based on the predetermined machine speed limit and variable machine parameters. The step of determining one or more control parameters comprises one or more of: varying a control software engine speed limit from a first engine speed value to a desired engine speed limit value, the desired engine speed limit value being based on the theoretical engine speed limit; setting the control software engine speed limit at a locked engine speed limit value, the locked engine speed limit value remaining constant when the theoretical engine speed limit is within a set range; setting an engine governor gain based on the theoretical engine speed limit; setting control software engine speed filter parameters based on the theoretical engine speed limit; and determining control commands to prevent the machine transmission from changing gears on the basis of the engine speed limit with a hysteresis applied.

An engine controller for effecting a predetermined machine speed limit in an engine that forms part of a machine, comprises a processor, configured to determine one or more control parameters for the engine on the basis of a theoretical engine speed limit that is based on a predetermined machine speed limit and variable machine parameters. The processor is configured to determine one or more control parameters by one or more of: a control software engine speed limit from a first engine speed value to a desired engine speed limit value, the desired engine speed limit value being based on the theoretical engine speed limit; setting the control software engine speed limit at a locked engine speed limit value, the locked engine speed limit value remaining constant when the theoretical engine speed limit is within a set range; setting an engine governor gain based on the theoretical engine speed limit; setting control software engine speed filter parameters based on the theoretical engine speed limit; and determining control commands to prevent the machine transmission from changing gears on the basis of the engine speed limit with a hysteresis applied.

### BRIEF DESCRIPTION OF THE DRAWINGS

The method of controlling the engine and engine controller may be put into practice in various ways, one of which will now be described by way of example only and with reference to the accompanying drawings in which:

FIG. 1 shows a schematic illustration of a control system for implementing a machine speed limit;

FIG. 2 shows an example of variation in actual engine speed over time when an engine speed limit is set, illustrating ramping the engine speed limit as part of the implementation of FIG. 1; and

FIG. 3 shows an example of variation in actual engine speed over time, illustrating a hold time for changing governor gains as part of the implementation of FIG. 1.

### DETAILED DESCRIPTION

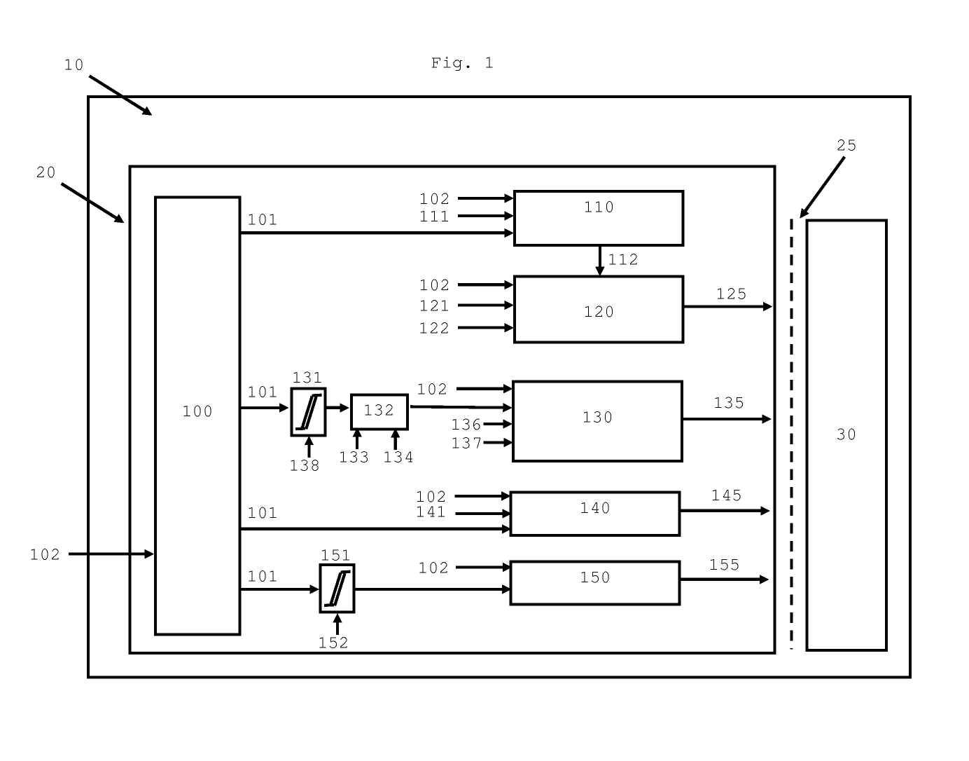

Referring first to FIG. 1, there is shown a schematic illustration of a control system 10 for implementing a machine speed limit. The control system may comprise: engine application software 20; an interface 25; and a core engine software 30.

The core engine software 30 may receive one or more parameters as inputs from the engine application software 20 over the interface 25, which may be internal to software. The engine application software 20 may comprise a number of logical blocks, which may include: a theoretical engine speed limit determination block 100; a locked engine speed limit determination block 110; a ramping block 120; an engine governor gains determination block 130; an engine speed filter determination block 140; and an SPN 1437 setting block 150.

The engine application software 20 may be provided with a predetermined Machine Speed Limit (MSL) as an input. The MSL may be programmed into the software, possibly by a technician. Alternatively, the MSL may be provided by a another part of the machine control software. For example, the MSL may be received wirelessly or established by a location determination means (for example, GPS) when in a geographical region where a speed limit is imposed or desirable.

This MSL may be provided to the theoretical engine speed limit determination block 100, which may determine a theoretical engine speed limit 101. The theoretical engine speed limit determination block 100 may determine an engine speed to sustain a desired machine speed. The determination may be based on fixed parameters of the machine, such as tire circumference, axle, gear and dimensions, and variable parameters of the machine, such as terrain, gear selection and load. It may also be based on the actual engine speed 102. The variable parameters of the machine may vary over time and the determined theoretical engine speed limit 101 may vary in consequence. A number of control parameters may be provided as outputs from the engine application software 20.

A first output from the engine application software 20 may be a desired engine speed limit 125 to be provided to the core engine software 30. This may control the level of fuel provided to the engine cylinders. The core engine software 30 may set the desired engine speed on the basis of a number of factors, including the desired engine speed limit 125.

An engine speed governor may be of two different types. A first type is referred to as an all speed or full range governor, which is speed-based and may allow the operator to provide an input to request a desired engine speed directly. The full range of the accelerator pedal travel may be required to sweep the engine speed from low to high idle. The second type is referred to as a MinMax governor, which is power-based or torque-based. This may provide an open-loop, operator controlled engine output, until the engine speed reaches a minimum value or maximum value. The operator may directly request engine power output between low and high idle.

In some types of engine, such as those having a MinMax governor, it may not be possible to provide the desired engine speed as a direct input to the core engine software. Instead, only the desired engine speed limit 125 may be provided. In these types of engine, a desired engine speed limit 125 may be provided to the core engine software. Other types of engine, such as all those having an all speed or full range governor, may allow the core engine software to receive a desired engine speed as an input. The provision of a desired engine speed limit 125 may not be suitable for these types of engine.

As noted above, the theoretical engine speed limit 101 may be based on variable parameters, so it may be constantly changing. A locked engine speed limit determination block 110 may be provided to determine a locked engine speed limit 112 on the basis of the theoretical engine speed limit 101.

This may be achieved by providing upper and lower limits, between which the engine speed limit may fluctuate or oscillate. This may cause the fuel provided to the engine to vary significantly, which might be undesirable. Lock parameters 111 may be provided to the locked engine speed limit determination block 110 to assist with determination of the oscillations. The locked engine speed limit 112 may be determined once the theoretical engine speed limit 101 meets stability parameters, which may be set on the basis of the lock parameters 111. These may include an upper limit and a lower limit and the locked engine speed limit 112 may be determined by taking a mean or mid-point between the upper and lower limits. For example, the lower limit may be determined as 1400 rpm and the upper limit may be determined as 1600 rpm.

Once the theoretical engine speed limit 101 remains within the upper limit and lower limit of the lock parameters 111 for a predetermined period of time, the locked engine speed limit determination block 110 may then output the mid-point value as the locked engine speed limit 112, which in the example case would be 1500 rpm. Once the locked engine speed limit 112 has been set, variation of the theoretical engine speed limit 101 between the upper and lower limits may not cause the locked engine speed limit 112 to change.

However, if the oscillations increase or shift such that they fall outside one of the limits, new limits may then be selected. A new mid-point value may then be outputted as the locked engine speed limit 112, once the theoretical engine speed limit 101 remains within the new upper limit and lower limit for the predetermined period of time. For example, the theoretical engine speed limit 101 may increase above the determined upper limit, for example 1600 rpm in the above example. This may occur because of a gear change due to a terrain change, for instance. In such a case, new lower and upper limits may be selected, such as 1600 rpm and 1800 rpm. A new mid-point value of 1700 rpm may then be outputted as the locked engine speed limit 112.

The actual engine speed 102 may also be provided as an input to the locked engine speed limit determination block 110.

The locked engine speed limit may be provided directly to the core engine software 30 as the desired engine speed limit 125. However, an improvement to this may employ the ramping block 120.

In this improvement, the locked engine speed limit 112 may be fed to the ramping block 120, which may provide the desired engine speed limit 125 to the core engine software 30. The ramping block 120 may receive data about the actual engine speed 102. It may also receive an indication of the machine load. Moreover, it may receive unloaded ramp parameters 121, for use when the machine is unloaded and loaded ramp parameters 122, for use when the machine is under a load. The unloaded ramp parameters 121 and loaded ramp parameters 122 may specify a ramp rate.

Feeding the locked engine speed limit 112 directly to the core engine software 30 may result in a sudden change in speed, particularly when the difference between the actual engine speed and the locked engine speed limit 112 is significant. Instead, the ramping block 120 may determine the difference between the actual speed of the engine 102 and the locked engine speed limit 112. It may then output a changing value for the desired engine speed limit 125 to the core engine software 30, until the value of the locked engine speed limit 112 is reached. In other words, a control software engine speed limit may be varied in an incremental, decremental or stepwise over time on the basis of the actual engine speed 102 and the theoretical engine speed limit 101.

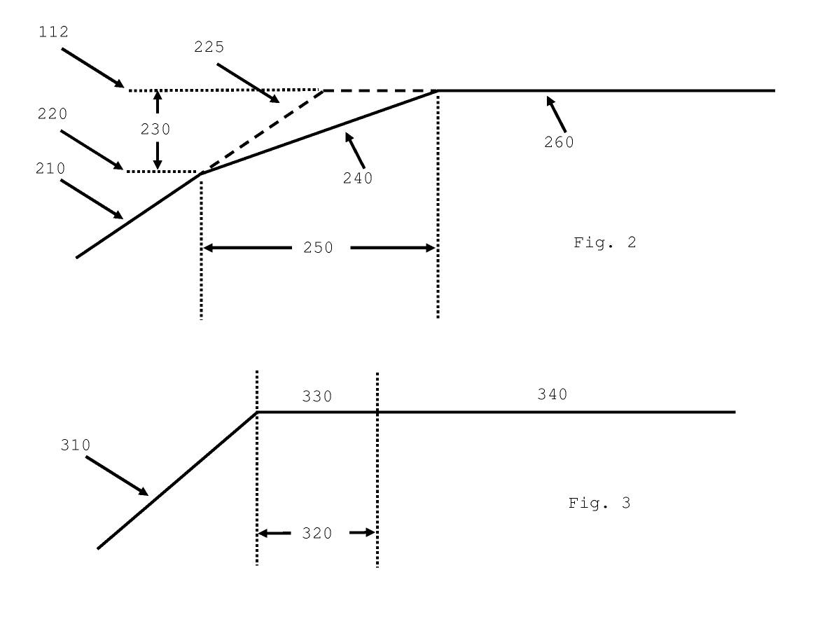

The rate of change may depend on the ramp rate specified in the ramp parameters. For example, when the actual engine speed is 1300 rpm and the locked engine speed limit 112 is determined as 1500 rpm, the output of the ramping block 130 (the desired engine speed limit 125) may linearly increase from 1300 rpm to 1500 rpm at a rate depending on the predefined ramp rate. More details of this implementation are provided below, with reference to FIG. 2.

A second output from the engine application software 20 may be engine governor gains 135. These may be determined by engine governor gains determination block 130. The engine governor may comprise one or more Proportional-Integral-Derivative (PID) controllers and changing the gains of the PID controller or controllers may affect the rate at which the actual engine speed changes in response to a change in software-controlled desired engine speed or operator-controlled throttle. Existing systems do not change the engine governor gains when an engine speed limit is set in comparison with the situation when no engine speed limit is set. By switching the governor gains when an engine speed limit is set, compensation can be made for the machine's inertia. The actual engine speed 102 may also be provided as an input.

The determination of engine governor gains 135 may also be based on the theoretical engine speed limit 101 provided by the theoretical engine speed limit determination block 100. The theoretical engine speed limit 101 may be provided to a hysteresis block 131. This may be used so that the determined governor gains will not switch when in a hysteresis area. In other words, an increase in the theoretical engine speed limit 101 may cause a change in the engine governor gains according to a first relationship, whereas a decrease in the theoretical engine speed limit 101 may cause a change in the engine governor gains according to a second, different relationship. In the first relationship, the engine governor gains may change when the theoretical engine speed limit 101 increases above a first threshold. In the second relationship, the engine governor gains may change when the theoretical engine speed limit 101 decreases below a second, different threshold. The hysteresis area may be the region between the two thresholds. This avoids intermittent governor gain changes. Hysteresis parameters 138 may be applied to the hysteresis block 131.

Also, a time delay block 132 may be used in providing the theoretical engine speed limit 101 to the engine governor gains determination block 130. In this way, the engine governor gains 135 may be adjusted at an appropriate interval following the change in determined theoretical engine speed limit 101. This may improve fuelling when switching governor gains. Moreover, the length of the time delay may be selected on the basis of the machine load. An unloaded timer value 133 may be provided for use when the machine is unloaded and a loaded timer value 134 may be provided for use when the machine is under a load.

The engine governor gains may also be different depending upon the level of the load provided to the machine. For example, unloaded governor gains 136 may be provided for use when the machine is unloaded and loaded governor gains 137 may be provided for use when the machine is under a load.

A third output from the engine application software 20 may be an engine speed filter factor 145. The engine speed filter factor 145 may affect a filter applied to an output signal from an engine speed sensor, for example affecting the way that noise is removed from the speed sensor output signal. This may also affect the responsiveness of the speed sensor's output to rapid changes in engine speed. Existing systems do not change the engine speed filter factor when an engine speed limit is set in comparison with the situation when no engine speed limit is set. Setting the engine speed filter factor 145 when the engine speed limit is set may help to stabilise the engine governor.

The engine speed filter factor 145 may be determined by the engine speed filter determination block 140. This may receive the theoretical engine speed limit 101 as an input. Optionally, the engine speed filter determination block 140 may receive an indication that an engine speed limit has been set instead of or in addition to the theoretical engine speed limit 101. It may also receive an application filter factor 141 as an input, which may affect the engine speed filter factor 145 depending on the actual engine speed 102, for example to adjust the engine speed filter factor 145 differently with engine speed. The actual engine speed 102 may also be provided as an input.

A fourth output from the engine application software 20 may be an SPN 1437 state 155. SPN 1437 is a communications parameter specified by the Society of Automotive Engineers (SAE) standards, defining road speed limit status. This maximum speed limit feature may be used on machines with automatic transmission. The torque converter may cause a shift in the gear based on the throttle position. When this feature is active, the desired engine speed may be limited even though the throttle is depressed fully. Hence, when this feature is controlling the desired engine speed, SPN 1437 may desirably be transmitted in a datalink to the ECM, so that the transmission ECM may not shift the gears even when the throttle is depressed fully. This parameter may be determined by the SPN 1437 setting block 150, to indicate to the transmission not to change the gears under certain circumstances, or to restrict gear changes, when an engine speed limit is in place. It may prevent the machine from changing gear unnecessarily, such as in response to a misinterpreted speed change. For example, when a machine speed limit is set, machine speed changes (possibly including engine speed changes) may be caused by the limit being imposed. By setting the SPN 1437 state appropriately, such speed changes may not be misinterpreted to indicate a speed change requiring a change in gear, such as a terrain change.

This determination may be based on the theoretical engine speed limit 101 with a hysteresis applied by hysteresis block 151. This may be used so that the SPN 1437 will not change its state in the hysteresis area to avoid frequent fluctuation. The general meaning of the term hysteresis area is explained above with reference to the hysteresis block 131 and it will be understood here with reference to the SPN 1437 state. Hysteresis parameters 152 may be applied to the hysteresis block 151. The actual engine speed 102 may also be provided as an input.

Referring next to FIG. 2, there is shown an example of variation in actual engine speed 102 over time, when an engine speed limit is set. This may illustrate ramping the engine speed limit, in accordance with the ramping block 120 shown in FIG. 1 and described above.

Initially the actual engine speed 102 may be increasing at a first rate 210 towards the locked engine speed limit 112. A target speed offset 220, which is a specified first engine speed value, may be defined by the ramping block 120, for example in rpm. This may be a static or constant value or may be changed dependent upon the load applied to the machine. The target engine speed offset 220 may be based on desired engine speed limit 125. The gap 230 between the locked engine speed limit 112 and the target speed offset 220 is shown. The target speed offset 220 may initially be provided by the ramping block 120 to the core engine software 30 as the desired engine speed limit 125.

When the actual engine speed 102 reaches the target engine speed offset 220, the ramping block 120 begins to adjust the desired engine speed limit 125 further. Instead of allowing the actual engine speed to increase (or decrease) towards the locked engine speed limit 112 at the same rate as it had previously been increasing (or decreasing), along path 225, the ramp rate may be reduced. The target engine speed offset 220 may therefore be a threshold level, the desired engine speed limit 125 being adjusted from the first engine speed value (the target engine speed offset 220) towards the locked engine speed limit 112. To achieve this, the desired engine speed limit 125 may be increased by the ramping block 120 at a second, lower ramp rate along path 240. It may then reach the locked engine speed limit 112 and may remain at that value along path 260. It be also be considered that the desired engine speed limit 125 may be adjusted from the actual engine speed (as the first engine speed value) towards the locked engine speed limit 112.

The target speed offset ramp rate may define, for example in rpm/s, the rate at which the engine speed limit 125 increases in second ramp rate time period 250, over speed range 230. The target speed offset 220 and the ramp rate (defined by period 250 and range 230) may be chosen such that the ramp rate is equal to or lower than the rate of change of actual engine speed prior to reaching the target speed offset 220.

The skilled person will appreciate that other incremental, decremental or stepwise changes in the engine speed limit may be possible. Alternative arrangements may include a constantly changing ramp rate, resulting in a non-linear ramping.

The skilled person will also appreciate that it may be necessary to reduce the engine speed to comply with a reduced machine speed limit. Such a scenario may arise where the machine may enter a geographical region with a reduced speed limit and may receive a signal indicative of that new machine speed limit. In this scenario, the theoretical engine speed limit 101 may reduce, which may cause a reduction in the locked engine speed limit 112 and consequent reduction in the control software engine speed limit 125.

Referring now to FIG. 3, there is shown an example of variation in actual engine speed limit 102 over time. This may illustrate a hold time for changing governor gains in the engine governor gains determination block 130 of FIG. 1.

Initially, the actual engine speed 102 may be increased along a ramp 310. When the actual engine speed reaches the locked engine speed limit value 112, a hold time period 330 of hold time duration 320 begins. In this hold time period 330, the standard governor gains for a system without an engine speed limit may continue to remain applied. This hold time duration may be a static or constant value or may be changed dependent upon the load applied to the machine. The hold time may be implemented by means of the time delay block 132, shown in FIG. 1.

The implementation described above, by delaying the change in engine governor gains for a period of time following the actual engine speed reaching the engine speed limit may advantageously improve the fuel efficiency of the engine, because of lag in the system. It may also result in improved stability of control when applying a machine speed limit.

Although embodiments of the disclosure have been described above, the skilled person may contemplate various modifications. For example, although the components of the system have been described working together, the skilled person may implement them separately. They may be implemented as any combination of hardware, firmware or software, as part of an engine ECU, as a separate module or distributed across a number of different modules within a system. This may make use of one processor, or multiple processors acting as one. A single engine governor gain may be used rather than multiple engine governor gains. More than one engine speed filter factor may be applied. It may be indicated to the transmission not to change the gears when an engine speed limit is in place using means other than an SPN 1437 state.

Although the desired engine speed limit 125 may be adjusted from the target engine speed offset 220 to the locked engine speed limit 112 when the actual engine speed reaches that target engine speed offset 220, the skilled person may consider alternatives. For example, when the actual engine speed reaches that target engine speed offset 220, the desired engine speed limit 125 may be at a different value from the target engine speed offset 220. Then, the desired engine speed limit 125 may be adjusted from that different value to the locked engine speed limit 112.

1. A method of controlling an engine forming part of a machine, in order to effect a predetermined machine speed limit, the method comprising:
determining one or more control parameters for the engine on the basis of a theoretical engine speed limit that is based on the predetermined machine speed limit and variable machine parameters;
wherein the step of determining one or more control parameters comprises one or more of: varying a control software engine speed limit from a first engine speed value to a desired engine speed limit value, the desired engine speed limit value being based on the theoretical engine speed limit; setting the control software engine speed limit at a locked engine speed limit value, the locked engine speed limit value remaining constant when the theoretical engine speed limit is within a set range; setting an engine governor gain based on the theoretical engine speed limit; setting control software engine speed filter parameters based on the theoretical engine speed limit; and determining control commands to prevent the machine transmission from changing gears on the basis of the engine speed limit with a hysteresis applied.

2. The method of claim 1, wherein the step of determining one or more control parameters comprises varying a control software engine speed limit between a first engine speed value and a desired engine speed limit value, the first engine speed value and the desired engine speed limit value being based on the theoretical engine speed limit.

3. The method of claim 1, wherein the step of determining one or more control parameters comprises varying a control software engine speed limit between a first engine speed value and a desired engine speed limit value and wherein the rate of ramping from the first engine speed value to the desired engine speed limit value is set on the basis of a level of load applied to the machine.

4. The method of claim 1, wherein the step of determining one or more control parameters comprises varying a control software engine speed limit between a first engine speed value and a desired engine speed limit value and wherein ramping of the control software engine speed limit from the first engine speed value to the desired engine speed limit value is started when the actual engine speed reaches a predetermined engine speed value.

5. The method of claim 4, wherein the predetermined engine speed value is the first engine speed value.

6. The method of claim 5, wherein the rate of ramping from the first engine speed value to the desired engine speed limit value is set to be lower than the rate of change in actual engine speed prior to the actual engine speed reaching the first engine speed value.

7. The method of claim 1, wherein the step of determining one or more control parameters comprises varying a control software engine speed limit between a first engine speed value and a desired engine speed limit value and wherein the first engine speed value is the actual engine speed.

8. The method of claim 1, wherein the step of determining one or more control parameters comprises varying a control software engine speed limit between a first engine speed value and a desired engine speed limit value and wherein the step of determining one or more control parameters further comprises setting the control software engine speed limit at a locked engine speed limit value and wherein the desired engine speed limit value is the locked engine speed limit value.

9. The method of claim 1, wherein the step of determining one or more control parameters comprises setting the control software engine speed limit at a locked engine speed limit value and wherein the set range is based on the theoretical engine speed limit.

10. The method of claim 9, wherein setting the control software engine speed limit at a locked engine speed limit value further comprises changing the set range from a first range to a second range when the theoretical engine speed limit changes from a first value that is inside the first range to a second value that is outside the first range, the second range being set on the basis of the second value of the theoretical engine speed limit.

11. The method of claim 1, wherein the step of determining one or more control parameters comprises setting the engine governor gain based on the theoretical engine speed limit and wherein the setting of the engine governor gain is further based on a level of load applied to the machine.

12. The method of claim 1, wherein the step of determining one or more control parameters comprises setting the engine governor gain based on the theoretical engine speed limit and wherein the setting of the engine governor gain is based on the theoretical engine speed limit with a hysteresis applied.

13. The method of claim 1, wherein the step of determining one or more control parameters comprises setting the engine governor gain based on the theoretical engine speed limit and wherein the setting of the engine governor gain is based on the theoretical engine speed limit with a time delay applied.

14. The method of claim 13, wherein the time delay is varied based on a level of load applied to the machine.

15. The method of claim 1, wherein the step of determining one or more control parameters comprises determining control commands to prevent the machine transmission from changing gears on the basis of the engine speed limit with a hysteresis applied and wherein the control commands comprise SPN 1437.

16. The method of claim 1, wherein the machine is automotive and the variable machine parameters comprise one or more of: terrain; gear selection; and load.

17. The method of claim 1, wherein the step of determining one or more control parameters comprises all of: varying a control software engine speed limit from a first engine speed value to a desired engine speed limit value, the desired engine speed limit value being based on the theoretical engine speed limit; setting the control software engine speed limit at a locked engine speed limit value, the locked engine speed limit value remaining constant when the theoretical engine speed limit is within a set range; setting an engine governor gain based on the theoretical engine speed limit; setting control software engine speed filter parameters based on the theoretical engine speed limit; and determining control commands to prevent the machine transmission from changing gears on the basis of the engine speed limit with a hysteresis applied.

18. A computer program, configured when operated on a processor to carry out the method of claim 1.

19. A computer readable medium comprising the computer program of claim 18.

20. An engine controller for effecting a predetermined machine speed limit in an engine that forms part of a machine, the engine controller comprising:
a processor, configured to determine one or more control parameters for the engine on the basis of a theoretical engine speed limit that is based on a predetermined machine speed limit and variable machine parameters;
wherein the processor is configured to determine one or more control parameters by one or more of: varying a control software engine speed limit from a first engine speed value to a desired engine speed limit value, the desired engine speed limit value being based on the theoretical engine speed limit; setting the control software engine speed limit at a locked engine speed limit value, the locked engine speed limit value remaining constant when the theoretical engine speed limit is within a set range; setting an engine governor gain based on the theoretical engine speed limit; setting control software engine speed filter parameters based on the theoretical engine speed limit; and determining control commands to prevent the machine transmission from changing gears on the basis of the engine speed limit with a hysteresis applied.

21. An engine comprising the engine controller of claim 20.
